(19) United States
(12) Patent Application Publication
(10) Pub. No.: US 2025/0130978 A1
(43) Pub. Date: Apr. 24, 2025

(54) INFORMATION PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Yonghui Pan, Beijing (CN); Yuanhui Liang, Beijing (CN); Zejian Lin, Beijing (CN); Biqing Guo, Beijing (CN); Qingyu Lai, Beijing (CN)

(21) Appl. No.: 18/889,257

(22) Filed: Sep. 18, 2024

(30) Foreign Application Priority Data
Oct. 20, 2023 (CN) 202311368446.5

(51) Int. Cl. G06F 16/178; G06F 21/62

(52) U.S. Cl. CPC G06F 16/178; G06F 21/6209; G06F 2221/2141

(57) ABSTRACT

The present disclosure provides an information processing method and apparatus, an electronic device, and a storage medium. The information processing method includes: creating a source synchronization block in a first document in response to a first operation event; and in response to a second operation event, generating, in a second document, a reference synchronization block that has a synchronization relationship with the source synchronization block, where the synchronization relationship includes: content in the source synchronization block being kept the same as content in the reference synchronization block, and an update to the content in the source synchronization block being synchronized with the content in the reference synchronization block; and an update to the content in the reference synchronization block being synchronized with the content in the source synchronization block.

### CROSS-REFERENCE TO RELATED APPLICATION(S)

This application claims priority to Chinese Application No. 202311368446.5 filed on Oct. 20, 2023, the disclosure of which is incorporated herein by reference in its entity.

### FIELD

The present disclosure relates to the field of computer technologies, and in particular, to an information processing method and apparatus, an electronic device, and a storage medium.

### BACKGROUND

A document is a carrier for information recording and exchange, and is also an important tool in office software. The document may be an online document, which can be used jointly by a plurality of collaborators, so as to implement collaborative office work.

### SUMMARY

The present disclosure provides an information processing method and apparatus, an electronic device, and a storage medium.

The following technical solutions are used in the present disclosure.

In some embodiments, the present disclosure provides an information processing method. The method includes:
creating a source synchronization block in a first document in response to a first operation event; and
in response to a second operation event, generating, in a second document, a reference synchronization block that has a synchronization relationship with the source synchronization block,
where the synchronization relationship includes: content in the source synchronization block being kept the same as content in the reference synchronization block, and an update to the content in the source synchronization block being synchronized with the content in the reference synchronization block; and an update to the content in the reference synchronization block being synchronized with the content in the source synchronization block.

In some embodiments, the present disclosure provides an information processing apparatus. The apparatus includes:
a creation unit configured to create a source synchronization block in a first document in response to a first operation event; and
a generation unit configured to, in response to a second operation event, generate, in a second document, a reference synchronization block that has a synchronization relationship with the source synchronization block,
where the synchronization relationship includes: content in the source synchronization block being kept the same as content in the reference synchronization block, and an update to the content in the source synchronization block being synchronized with the content in the reference synchronization block; and an update to the content in the reference synchronization block being synchronized with the content in the source synchronization block.

In some embodiments, the present disclosure provides an electronic device. The electronic device includes: at least one memory and at least one processor,
where the memory is configured to store program code, and the processor is configured to call the program code stored in the memory to perform the method described above.

In some embodiments, the present disclosure provides a computer-readable storage medium configured to store program code that, when executed by a processor, causes the processor to perform the method described above.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a flowchart of an information processing method according to an embodiment of the present disclosure;

FIG. 2 to FIG. 13 are schematic diagrams of display of a document during execution according to an embodiment of the present disclosure;

FIG. 14 is a flowchart of an information processing method according to an embodiment of the present disclosure; and

FIG. 15 is a schematic diagram of a structure of an electronic device according to an embodiment of the present disclosure.

### DETAILED DESCRIPTION OF EMBODIMENTS

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from a user, prompt information is sent to the user to clearly inform the user that a requested operation will require access to and use of personal information of the user. As such, the user can independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifier “one” mentioned in the present disclosure is illustrative and not restrictive, and those skilled in the art should understand that unless the context clearly indicates otherwise, the modifier should be understood as “one or more”.

The names of messages or information exchanged between a plurality of apparatuses in the implementations of the present disclosure are used for illustrative purposes only, and are not used to limit the scope of these messages or information.

The solutions provided in the embodiments of the present disclosure are described in detail below with reference to the accompanying drawings.

In the embodiments of the present disclosure, mutual synchronization between the source synchronization block and the reference synchronization block is implemented without a need to synchronize other content (e.g., content in a content block of another non-synchronization block) in the first document and the second document, which allows for module-level information synchronization and flow in the documents, and reduces the granularity of information flow as compared to document-level information flow.

A document is a carrier for information recording and exchange, and is also an important creation and collaboration tool in office software. In order to implement collaboration among different users, a collaborative online document is used in some technologies, whereby different users can collaborate on the same online document. However, the granularity of the collaboration is at a document level, and information flow is not flexible or sufficient for the implementation of document-level collaboration.

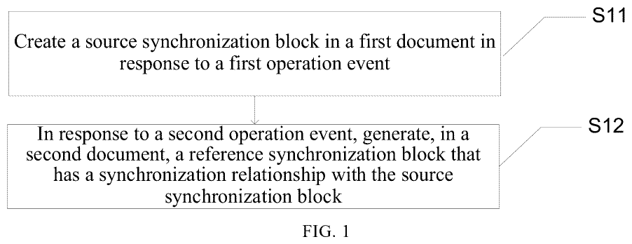

As shown in FIG. 1, FIG. 1 is a flowchart of an information processing method according to an embodiment of the present disclosure. The method includes the following steps.

S11: Create a source synchronization block in a first document in response to a first operation event.

S12: In response to a second operation event, generate, in a second document, a reference synchronization block that has a synchronization relationship with the source synchronization block.

In some embodiments, the first operation event may be an operation event performed in the first document, and the second operation event may be an operation event performed in the second document. The first document and the second document may be online documents. The source synchronization block and the reference synchronization block are both synchronization blocks, and have the synchronization relationship with each other. In some embodiments, a synchronization block is a content block of a special type, and the content block is a basic unit in a document that carries document content. The document has one or more content blocks, and the document content is located in the content block. The synchronization block is used to help a user to synchronize information between different document systems. The source synchronization block is an entity form in which the synchronization block is initially created, and the creation of the source synchronization block does not depend on another synchronization block. The reference synchronization block is an entity form of the source synchronization block after being synchronized, referenced, or shared, and the creation of the reference synchronization block depends directly or indirectly on the source synchronization block. In some embodiments, one reference synchronization block has a synchronization relationship with only one source synchronization block, and one source synchronization block may have a synchronization relationship with one or more reference synchronization blocks. In some embodiments, the synchronization relationship includes: content in the source synchronization block being kept the same as content in the reference synchronization block, and an update to the content in the source synchronization block being synchronized with the content in the reference synchronization block, such that the same update is made to the content in the reference synchronization block; and an update to the content in the reference synchronization block being synchronized with the content in the source synchronization block, such that the same update is made to the content in the source synchronization block.

In some embodiments of the present disclosure, the source synchronization block is created in the first document, and the reference synchronization block is created in the second document. A synchronization block is a content block of a special type, and the content block is a basic unit that carries document content. The first document and the second document each have one or more content blocks. When there is a need to write document content, the document content is written into the content block, and no content synchronization is performed between conventional content blocks. The synchronization block may have the document content, and the content of the source synchronization block is kept synchronous with the content of the reference synchronization block. As such, after the source synchronization block is modified in the first document, the reference synchronization block is modified automatically, while content in a content block of another non-synchronization block in the first document is not kept synchronous with content in a content block of a non-synchronization block in the second document. Similarly, after the source synchronization block is modified in the second document, the reference synchronization block is modified automatically, while the content of the other non-synchronization block in the first document is not kept synchronous with the content of the non-synchronization block in the second document. In the present disclosure, document content, other than the content of the source synchronization block and the reference synchronization block, in the first document does not need to be kept synchronous with document content, other than the content of the source synchronization block and the reference synchronization block, in the second document, that is, module-level synchronization is implemented. In the embodiments of the present disclosure, module-level mutual synchronization between the source synchronization block and the reference synchronization block is implemented without a need to synchronize the other content (e.g., the content in the content block of the other non-synchronization block) in the first document and the second document, which allows for module-level information synchronization and flow in the documents, and reduces the granularity of information transfer.

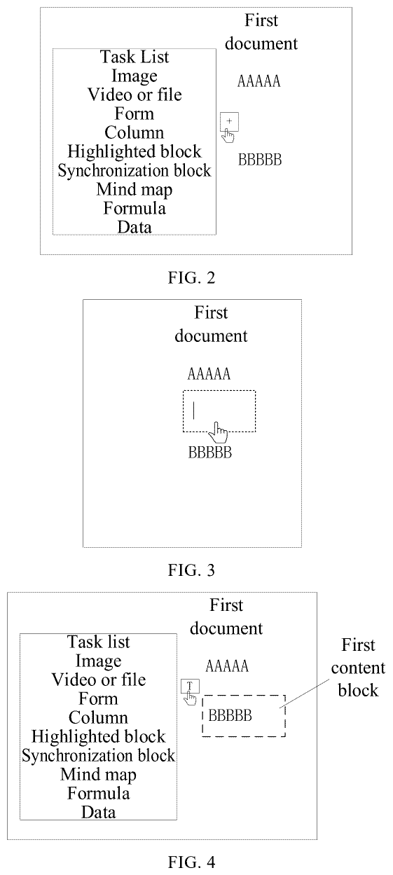

In some embodiments of the present disclosure, the creating a source synchronization block in a first document in response to a first operation event includes: creating an empty source synchronization block in the first document in response to a trigger operation on a first control for the first document. In some embodiments, as shown in FIG. 2, in the first document, a control entry (a box with a plus sign inside in FIG. 2) may be triggered in a blank area, and a list of controls is then displayed, the list of controls including the first control (“Synchronization Block” in a box on the left side of FIG. 2). By clicking on the first control, as shown in FIG. 3, the empty source synchronization block (a dashed line box in FIG. 3) is created in the first document, and an input identifier may be automatically displayed in the source synchronization block.

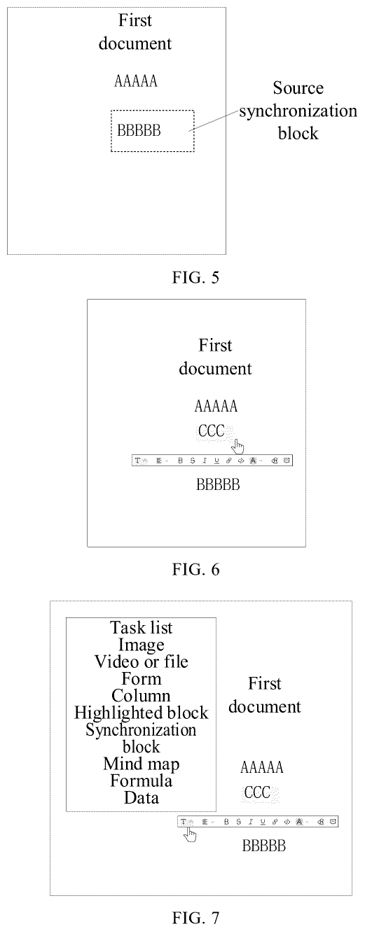

In some embodiments of the present disclosure, the creating a source synchronization block in a first document in response to a first operation event includes: in response to a trigger operation on a second control associated with a first content block of the first document, converting the first content block into the source synchronization block, the source synchronization block in the first document having original first content in the first content block. In some embodiments, as shown in FIG. 4, the first content block (a dashed line box where “BBBBB” is located in FIG. 4) is a content block of a non-synchronization block, and the first content block is provided with an associated list of controls. The list of controls may be displayed by triggering a control entry in the first content block, and the second control (“Synchronization block” in FIG. 4) may then be displayed in the list of controls, where the second control is used to convert the type of the content block. By triggering the second control, as shown in FIG. 5, the first content block is converted into the source synchronization block, and the content in the source synchronization block is original document content in the first content block, i.e., the first content (“BBBBB” in FIG. 4).

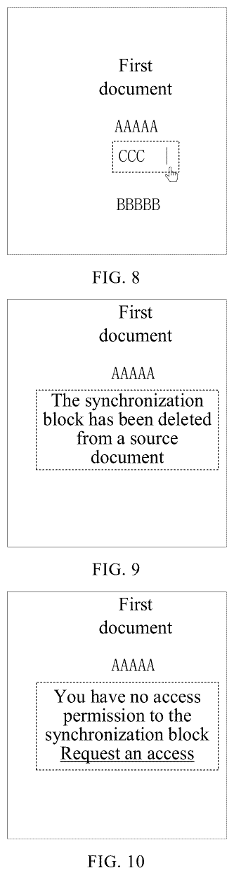

In some embodiments of the present disclosure, the creating a source synchronization block in a first document in response to a first operation event includes: in response to a preset operation on second content in the first document, displaying a third control associated with second content; and creating the source synchronization block in the first document in response to a trigger operation on the third control, the source synchronization block having the second content. In some embodiments, as shown in FIG. 6, the second content is document content of the first document, and the preset operation may be, for example, pulling and selecting the second content (“CCC” in FIG. 6) by, for example, dragging a mouse, where the second content may be part of or all of content in a content block of a non-synchronization block. After the preset operation is performed on the second content, a list of controls for the second content may be displayed, where there is a convert control in the list of controls, and the third control may be a control in the convert control that is used for converting the document content into content of a synchronization block (“Synchronization Block” in FIG. 7). Then, as shown in FIG. 8, the source synchronization block is generated, and the second content is located in the source synchronization block.

In some embodiments of the present disclosure, in response to a user who performs the first operation event having no edit permission to the first document, the creation of the source synchronization block in the first document is refused. In some embodiments, a user who has an edit permission to the first document can edit the document content of the first document, as the creation of the source synchronization block belongs to editing of the document content of the first document. Accordingly, the user needs to have the edit permission to edit the first document, otherwise the creation of the source synchronization block in the first document is refused.

In some embodiments of the present disclosure, the method further includes: granting a user of the first document a permission to the source synchronization block, where the permission of the user of the first document to the source synchronization block is the same as a permission of the user of the first document to the first document.

In some embodiments, after the source synchronization block is created, a permission setting for the source synchronization block follows a permission setting for the first document by default. A user may have a read permission, an edit permission, and other permissions to the first document, and the edit permission includes the read permission. If the user has the read permission, the edit permission, etc. to the first document, the user automatically has a read permission or an edit permission to the source synchronization block after the source synchronization block is created.

In some embodiments of the present disclosure, the content in the source synchronization block and the content in the reference synchronization block include: one or more of text, an image, a video, a document, a form, and a content block of a non-synchronization block, the content block being a basic unit that carries document content. In some embodiments of the present disclosure, document content may be written into the source synchronization block and the reference synchronization block, or may be written into a content block that is not a synchronization block (including the source synchronization block and the reference synchronization block), into which content block other document content may be written. The content in the source synchronization block and the reference synchronization block does not include: another source synchronization block or another reference synchronization block. That is, one synchronization block cannot be inserted into another synchronization block.

In some embodiments of the present disclosure, in response to a user having a comment permission to a document in which a target synchronization block is located, the user is granted a comment permission to the target synchronization block in the document. In some embodiments, in response to the user having no comment permission to the document in which the target synchronization block is located, the user is not granted the comment permission to the target synchronization block in the document. In some embodiments, the target synchronization block is the source synchronization block or the reference synchronization block. In other words, a user who has a comment permission to the first document also has a comment permission to the source synchronization block, and if the user has no comment permission to the first document, the user has no comment permission to the source synchronization block. A user who has a comment permission to the second document has a comment permission to the source synchronization block, and if the user has no comment permission to the second document, the user has no comment permission to the reference synchronization block.

In some embodiments of the present disclosure, in response to a comment operation on content in the target synchronization block, comment information is displayed in a document in which commented content is located, and at least one of the following is performed: refraining from synchronizing the comment information to another document, and sending a notification message to a user associated with the document in which the commented content is located. In some embodiments, a comment on the target synchronization block is mounted on the target synchronization block, so that a user who has a permission to view a comment on the first document can view comment information for content of a source content block, and a user who has a permission to view a comment on the second document can view comment information for content of a reference content block. The comment information may not be synchronized. The comment information for the content of the source synchronization block in the first document is displayed only in the first document in which a source document is located, and is not synchronized with the reference synchronization block or the document in which the reference synchronization block is located, and a notification message is sent to a user of the first document that is associated with the comment information. Similarly, a comment on the reference synchronization in the second document is not synchronized with the source synchronization block or the first document in which the source synchronization block is located, and a notification message is sent to a user of the second document that is associated with the comment information.

In some embodiments of the present disclosure, the second operation event includes: an operation of copying the source synchronization block or a link to the source synchronization block into the second document; or an operation of copying another reference synchronization block or a link to the other reference synchronization block into the second document, where the other reference synchronization block has a synchronization relationship with the source synchronization block in the first document.

In some embodiments, after the source synchronization block is generated, if the reference synchronization block has not been generated, the source synchronization block or the link to the source synchronization block may be copied, and then the source synchronization block or the link to the source synchronization block may be pasted into the second document, so as to generate the reference synchronization block. In some other embodiments, after the source synchronization block is generated, if another reference synchronization block has been generated by copying the source synchronization block or the link to the source synchronization block, a reference synchronization block may be generated in the second document by copying and then pasting the other synchronization block or a link to the other synchronization block into the second document. A synchronization relationship of this reference synchronization block depends on a synchronization relationship of the other reference synchronization block. As the other reference synchronization block has a synchronization relationship with the source synchronization block, the reference synchronization block in the second document has a synchronization relationship with the source synchronization block.

In some embodiments of the present disclosure, after the second operation event and before the generating, in a second document, a reference synchronization block that has a synchronization relationship with the source synchronization block, the method further includes: determining an access permission of a user who performs the second operation event to the second document.

In some embodiments, in response to the user who performs the second operation event having no edit permission to the second document, the generation of the reference synchronization block is refused. In some embodiments, the generation of the reference synchronization block in the second document belongs to editing of the second document. Accordingly, the edit permission to the second document is required to generate the reference synchronization block, otherwise the reference synchronization block cannot be generated in the second document.

In some embodiments, in response to the user who performs the second operation event having an edit permission to the second document, it is determined whether the user who performs the second operation event has a read permission to the source synchronization block; in response to the user who performs the second operation event having a read permission to the source synchronization block, the step of generating, in a second document, a reference synchronization block that has a synchronization relationship with the source synchronization block is performed; or in response to the user who performs the second operation event having an edit permission to the second document but having no read permission to the source synchronization block, a link to the source synchronization block is displayed in the second document, and the reference synchronization block is not generated.

In some embodiments, if the user who performs the second operation event has the edit permission to the second document, it is required to further determine whether the user has the read permission to the source synchronization block. If the user has the read permission to the source synchronization block, the reference synchronization block is generated in response to the second operation event. If the user has no read permission to the source synchronization block, the link to the reference synchronization block is generated in the second document in response to the second operation event, instead of generating the reference synchronization block. As the user has no permission to read the source synchronization block, the reference synchronization block cannot be generated, otherwise the content in the source synchronization block may be leaked by the reference synchronization block due to the presence of the synchronization relationship.

In some embodiments of the present disclosure, after the displaying a link to the source synchronization block in the second document, the method further includes: in response to an access operation on the link to the source synchronization block, determining whether a user who performs the access operation has a read permission to the source synchronization block; and in response to the user who performs the access operation having an access permission to the source synchronization block, making a jump to a unique access page for the source synchronization block; or in response to the user who performs the access operation having no read permission to the source synchronization block, making a jump to a permission request page, the permission request page being used to request a permission to the source synchronization block.

In some embodiments, as the user who performs the second operation event has no read permission to the source synchronization block, the link to the source synchronization block is displayed in the second document, so that the user or another user may access the source synchronization block later by, for example, clicking on the link (an access operation). If the user who performs the access operation has the access permission to access the source synchronization block (e.g., has the read permission to the source synchronization block), the content of the source synchronization block is displayed in a separate page, which avoids leakage of other content of the first document. If the user has no read permission to the source synchronization block, the jump is made to the permission request page to request the access permission to the source synchronization block.

In some embodiments of the present disclosure, after the generating, in a second document, a reference synchronization block that has a synchronization relationship with the source synchronization block, the method further includes: determining whether a user who performs the second operation event has a collaborator management permission to the reference synchronization block.

In some embodiments, in response to the user who performs the second operation event having a collaborator management permission to the reference synchronization block, a collaborator of the second document is granted a read permission to the reference synchronization block. In some embodiments, after the reference synchronization block is created in the second document, if the user who performs the second operation event has the collaborator management permission, it indicates that the user can manage a collaborator of the reference synchronization block. The collaborator management permission has a higher priority than the edit permission and the read permission. Therefore, after the user creates the reference synchronization block in the second document, a collaborator of the second document is granted a read permission to the reference synchronization block by default, so that the collaborator of the second document also becomes a collaborator of the reference synchronization block. Moreover, the user who performs the second operation event can manually manage a permission of the collaborator of the second document to the reference synchronization block, e.g., by switching the permission of the collaborator of the second document to the reference synchronization block to an edit permission or a management permission. A collaborator of a document is a user who has at least a permission to read the document. After the collaborator of the second document is granted the read permission to the reference synchronization block, a notification is sent to an owner of the source synchronization block, and a user who has an administrator permission to the source synchronization block and the reference synchronization block.

In some embodiments, in response to the user who performs the second operation event having no collaborator management permission to the reference synchronization block, the user who performs the second operation event in collaborators of the second document is configured to be allowed to view the reference synchronization block, or the user who performs the second operation event in the collaborators of the second document is configured to be allowed to view the reference synchronization block, and first prompt information is displayed to give a prompt that another collaborator of the second document is not allowed to view the reference synchronization block. In some embodiments, as the user who performs the second operation event has no collaborator management permission, the user cannot add another user as a collaborator of the reference synchronization block, in which case only this user can view the reference synchronization block, and another collaborator of the second document is not automatically granted a read permission to the reference synchronization block. Moreover, the first prompt information is displayed, so that the user learns that the content of the reference synchronization block is inaccessible to the collaborator or some collaborators of the second document, and the user may request a permission to the reference synchronization block for the collaborator of the second document.

In some embodiments, by copying and pasting the source synchronization block, the reference synchronization block, the link to the source synchronization block, or the link to the reference synchronization block in the first document, a reference synchronization block that has a synchronization relationship with the source synchronization block is generated in the first document. However, since the reference synchronization block is located in the same document as the source synchronization block, authorization of the source synchronization block by another user is not triggered, and accordingly, no notification message will be sent as a result of the authorization.

In some embodiments of the present disclosure, in response to the source synchronization block being deleted from the first document, first preset content is displayed at a position where the reference synchronization block is located in the second document.

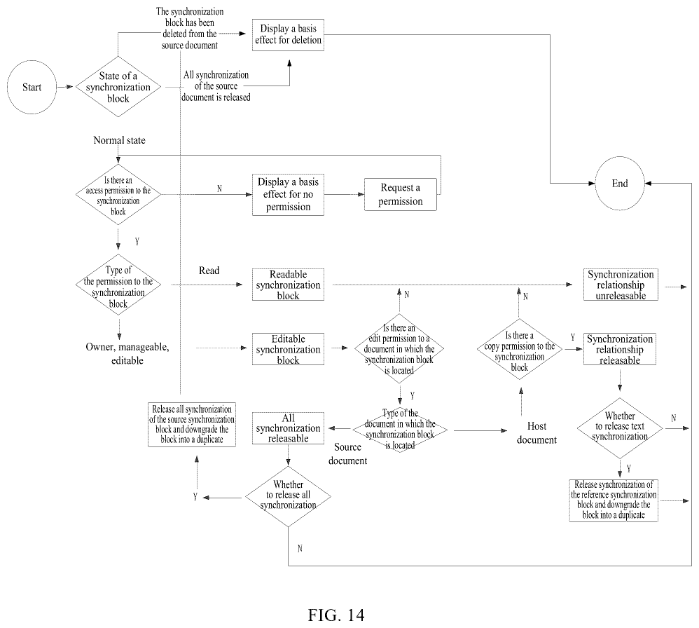

In some embodiments of the present disclosure, as shown in FIG. 14, the state of the synchronization block (the source synchronization block and the reference synchronization block) is determined if the second document is opened. If the source synchronization block is deleted, the reference synchronization block is not displayed in the second document, and a basic effect that the source synchronization block has been deleted (the first preset content) is displayed at the position where the reference synchronization block is located. The first preset content “The synchronization block has been deleted from the source document” is schematically shown in FIG. 9, where the source document is the first document in which the source synchronization block is located.

In some embodiments of the present disclosure, in response to the synchronization relationship between the source synchronization block and the reference synchronization block being released in the first document, the reference synchronization block is not displayed in the second document, and second preset content is then displayed at a position where the reference synchronization block is located. In some embodiments, if synchronization relationships between the source synchronization block and all the reference synchronization blocks are released in the first document, the reference synchronization block is replaced with the second preset content in the second document, where the second preset content may be the same as or different from the first preset content. The second preset content is displayed while the content in the source synchronization block is not displayed, which avoids leakage of the content in the source synchronization block.

In some embodiments of the present disclosure, in response to a user who views a target synchronization block having a read permission to the target synchronization block, the target synchronization block is displayed, or in response to the user who views the target synchronization block having no read permission to the target synchronization block, the target synchronization block is not displayed, and third preset content is then displayed at a position where the target synchronization block is originally located, where the target synchronization block is the source synchronization block or the reference synchronization block.

In some embodiments, in the first document or the second document, if a user does not have a read permission to view the source synchronization block or the reference synchronization block in the document, the third preset content is displayed. As shown in FIG. 10, the third preset content may be a notification that the user has no access permission to access the target synchronization block, and there may be an entry for requesting an access permission to the target synchronization block in the third preset content.

In some embodiments of the present disclosure, in response to a user having a read permission to the first document, the user is granted a read permission to a target synchronization block. In some embodiments of the present disclosure, in response to a user having an edit permission to the first document, the user is granted an edit permission to the target synchronization block. In some embodiments of the present disclosure, in response to a user having a unique authorization for the target synchronization block, a permission of the user to the target synchronization block is determined based on the unique authorization. In some embodiments of the present disclosure, a user who has neither a read permission to the first document nor a unique authorization for the target synchronization block has no access permission to the target synchronization block, where a user who has a read permission or an edit permission to the target synchronization block has an access permission to the target synchronization block, and the target synchronization block is the source synchronization block or the reference synchronization block.

In some embodiments, as shown in FIG. 14, when the target synchronization block is in a normal state, a permission of a user to the source synchronization block or the reference synchronization block follows a permission of the user to the first document in which the source synchronization block is located. Accordingly, if the user can edit or read the first document, they can edit or read the source synchronization block or the reference synchronization block (the edit permission includes the read permission). If the user cannot read the first document, it is further determined whether the user has a unique authorization for the source synchronization block or the reference synchronization block. If the user has a unique read permission or edit permission to the source synchronization block or the reference synchronization block, they can read or edit the source synchronization block or the reference synchronization block.

In some embodiments of the present disclosure, the method further includes: displaying a list of synchronization documents in response to a third operation event on a fourth control associated with a target synchronization block, where the target synchronization block is the source synchronization block or the reference synchronization block, and the list of synchronization documents includes: a document identifier of a document having the source synchronization block, and a document identifier of a document having the reference synchronization block.

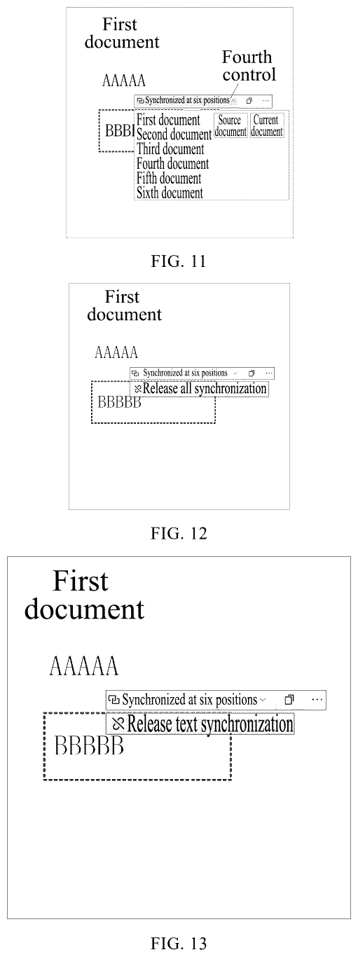

In some embodiments, as shown in FIG. 11, the list of synchronization documents may be displayed by performing a trigger operation, such as clicking, on the fourth control associated with the source synchronization block in the first document (i.e., the source document) or the reference synchronization block in the second document (i.e., a host document), so as to inform the user to which documents the content of the source synchronization block is synchronized.

In some embodiments of the present disclosure, the fourth control is displayed in response to a user who accesses the target synchronization block having a read permission to the synchronization block. In some embodiments, only a user who has a read permission to the target synchronization block can view the fourth control associated with the target synchronization block.

In some embodiments of the present disclosure, an identifier of a document to which a user who performs the third operation event has a view permission is displayed in the list of synchronization documents. In some embodiments, only an identifier of a document that the user has a permission to view is displayed in the list of synchronization documents, so as to avoid information leakage. In some embodiments of the present disclosure, second prompt information is displayed in the list of synchronization documents, to give a prompt of a number of document identifiers that are not displayed in the list of synchronization documents.

In some embodiments of the present disclosure, in response to a synchronization relationship of the target synchronization block being released, the fourth control associated with the synchronization block is not displayed. In some embodiments, if the synchronization relationship of the target synchronization block is released, there is no other synchronization block that is synchronized with the target synchronization block, and therefore, the fourth control does not need to be displayed.

The number of document identifiers in the list of synchronization documents is displayed in the fourth control. In some embodiments, as shown in FIG. 11, “Synchronized at six positions” is displayed in the fourth control, so as to inform the user how many documents have a synchronization block (including the source synchronization block and the reference synchronization block) therein.

In some embodiments of the present disclosure, a document identifier of the first document, in which the source synchronization block is located, in the list of synchronization documents is associated with a first mark. In some embodiments, a document identifier of a current document, in which the target synchronization block is located, in the list of synchronization documents is associated with a second mark. In some embodiments, as shown in FIG. 11, “Source document” is displayed on the right side of the first document in the list of synchronization documents, indicating that the first document is a document in which the source synchronization block is located, and “Current document” is displayed, indicating that the first document is a document that the user is currently accessing.

In some embodiments of the present disclosure, in response to a fourth operation event on the document identifier in the list of synchronization documents, a document to which the document identifier subjected to the fourth operation event is pointing is opened, and a target synchronization block in the document is located. In some embodiments, the fourth operation event may be clicking on a document identifier, opening a document to which the document identifier is pointing, and locating to a target synchronization block in the document.

In some embodiments, in the list of synchronization documents, document identifiers of the first document and the current document are displayed preferentially in the order of the first document, the current document, and another document. Even if there are a plurality of synchronization blocks in one document, a document identifier of the document is displayed only once. If there are a plurality of synchronization blocks in the document to which the document identifier subjected to the fourth operation event is pointing, a synchronization block with the most recently synchronized content is located.

In some embodiments of the present disclosure, the method further includes: in response to a fifth operation event based on the source synchronization block, releasing synchronization relationships between the source synchronization block and all the reference synchronization blocks. In some embodiments, as shown in FIG. 12, the source synchronization block may be provided with a control for releasing the synchronization relationships between the source synchronization block and all the reference synchronization blocks. By triggering the control, the synchronization relationship between the source synchronization block and each reference synchronization block may be released, after which the content synchronization is no longer maintained. During release of the synchronization relationships between the source synchronization block and all the reference synchronization blocks, a pop-up window may be displayed to ask the user for confirmation, and after confirmation, the synchronization relationships between the source synchronization block and all the reference synchronization blocks are released.

In some embodiments of the present disclosure, in response to a user who performs the fifth operation event having no edit permission to the first document, the release of the synchronization relationships between the source synchronization block and all the reference synchronization blocks is refused. In some embodiments, the release of the synchronization relationship means that the document content in the first document changes, and therefore, an edit permission to the first document is required.

In some embodiments of the present disclosure, after the synchronization relationships between the source synchronization block and all the reference synchronization blocks are released, the content of the source synchronization block is converted into content of a non-synchronization block in the first document. In some embodiments, after the synchronization relationships between the source synchronization block and all the reference synchronization blocks are released, the source synchronization block becomes an ordinary content block of a non-synchronization block type, where content in the content block is the original content in the source synchronization block, but is not synchronized with the content of the reference synchronization block.

In some embodiments of the present disclosure, after the synchronization relationships between the source synchronization block and all the reference synchronization blocks are released, a link to the source synchronization block is made inaccessible. Since the source synchronization block has become an ordinary content block, the link to the block is invalid and inaccessible.

In some embodiments of the present disclosure, after the synchronization relationships between the source synchronization block and all the reference synchronization blocks are released, in response to the link to the source synchronization block being pasted into a third document, a reference synchronization block is not generated in the third document. Since the source synchronization block has become an ordinary content block at this time, the reference synchronization block is not generated. In this case, the pasted link may be displayed as a link only.

In some embodiments of the present disclosure, the method further includes: in response to an operation of undoing the fifth operation event, restoring the synchronization relationships between the source synchronization block and all the reference synchronization blocks. In some embodiments, the source synchronization block that has become an ordinary content block may be restored through operations such as rollback and undo, and therefore, the synchronization relationship may also be restored.

In some embodiments of the present disclosure, the method further includes: in response to a sixth operation event based on the reference synchronization block in the second document, releasing the synchronization relationship between the reference synchronization block in the second document and the source synchronization block.

In some embodiments, as shown in FIG. 13, the synchronization relationship between the reference synchronization block in the second document and the source synchronization block may be released individually in the second document, in which case a synchronization relationship between the source synchronization block and another reference synchronization block is retained. During release of the synchronization relationship between the reference synchronization block in the second document and the source synchronization block, a pop-up window may be provided to give a prompt of whether to release the synchronization relationship, and after confirmation of the release, the synchronization relationship is released.

In some embodiments of the present disclosure, in response to a user who performs the sixth operation event having no edit permission to the second document or having no copy permission to the reference synchronization block, the release of the synchronization relationship between the reference synchronization block in the second document and the source synchronization block is refused. In some embodiments, the type of the reference synchronization block in the second document is changed by the sixth operation event, and the reference synchronization block thus becomes an ordinary content block, involving an edit operation. Therefore, the edit operation is required. However, after execution of the sixth operation event, the content of the reference synchronization block remains in the ordinary content block that the reference synchronization block becomes, which is equivalent to copying the content of the reference synchronization block into the second document. Therefore, the copy permission to the reference synchronization block is required. If the two permissions are available, the synchronization relationship between the reference synchronization block in the second document and the source synchronization block can be released, otherwise the synchronization relationship between the reference synchronization block in the second document and the source synchronization block cannot be released.

In some embodiments of the present disclosure, after the synchronization relationship between the reference synchronization block in the second document and the source synchronization block is released, the content of the reference synchronization block in the second document is converted into content of a non-reference synchronization block. In some embodiments, the content of the reference synchronization block is converted into content of an ordinary content block of a non-synchronization block, and may continue to be displayed in the second document, but is not kept synchronous with the content of the source synchronization block.

In some embodiments of the present disclosure, after the synchronization relationship between the reference synchronization block in the second document and the source synchronization block is released, display of the second document in the list of synchronization documents is disabled. It should be noted that, if there are a plurality of reference synchronization blocks in the second document, and only some of them are desynchronized from the source document, but some of the reference synchronization blocks still have a synchronization relationship with the source document, the document identifier of the second document is still displayed in the list of synchronization documents. If the synchronization relationships between all the reference synchronization blocks in the second document and the source synchronization block are released, the document identifier of the second document is not displayed in the list of synchronization documents.

In some embodiments of the present disclosure, the method further includes: in response to an operation of undoing the sixth operation event, restoring the reference synchronization block in the second document and the synchronization relationship between the reference synchronization block and the source synchronization block.

In some embodiments, the reference synchronization block that has become the ordinary content block may be restored by means of withdrawing, rolling back historical records, etc., and the synchronization relationship between the reference synchronization block and the source synchronization block may be restored.

The present disclosure further provides an information processing apparatus. The apparatus includes:
a creation unit configured to create a source synchronization block in a first document in response to a first operation event; and
a generation unit configured to, in response to a second operation event, generate, in a second document, a reference synchronization block that has a synchronization relationship with the source synchronization block,
where the synchronization relationship includes: content in the source synchronization block being kept the same as content in the reference synchronization block, and an update to the content in the source synchronization block being synchronized with the content in the reference synchronization block; and an update to the content in the reference synchronization block being synchronized with the content in the source synchronization block.

In some embodiments, the creating a source synchronization block in a first document in response to a first operation event includes:
creating an empty source synchronization block in the first document in response to a trigger operation on a first control for the first document; or
in response to a trigger operation on a second control associated with a first content block of the first document, converting the first content block into the source synchronization block, the source synchronization block in the first document having original first content in the first content block; or
in response to a preset operation on second content in the first document, displaying a third control associated with second content; and creating the source synchronization block in the first document in response to a trigger operation on the third control, the source synchronization block having the second content.

In some embodiments, the creation unit is further configured to, in response to a user who performs the first operation event having no edit permission to the first document, refuse the creation of the source synchronization block in the first document.

The information processing apparatus further includes a control unit configured to grant a user of the first document a permission to the source synchronization block, where the permission of the user of the first document to the source synchronization block is the same as a permission of the user of the first document to the first document.

In some embodiments, the content in the source synchronization block and the content in the reference synchronization block include: one or more of text, an image, a video, a document, a form, and a content block of a non-synchronization block, the content block being a basic unit that carries document content.

In some embodiments, the content in the source synchronization block and the content in the reference synchronization block do not include: another source synchronization block or another reference synchronization block.

In some embodiments, the control unit is further configured to, in response to a user having a comment permission to a document in which a target synchronization block is located, grant the user a comment permission to the target synchronization block in the document, the target synchronization block being the source synchronization block or the reference synchronization block.

In some embodiments, the control unit is further configured to, in response to the user having no comment permission to the document in which the target synchronization block is located, refrain from granting the user the comment permission to the target synchronization block in the document.

In some embodiments, the control unit is further configured to, in response to a comment operation on content in the target synchronization block, display comment information in a document in which commented content is located, and perform at least one of the following: refraining from synchronizing the comment information to another document, and sending a notification message to a user associated with the document in which the commented content is located.

In some embodiments, the second operation event includes:
an operation of copying the source synchronization block or a link to the source synchronization block into the second document; or
an operation of copying another reference synchronization block or a link to the other reference synchronization block into the second document, where the other reference synchronization block has a synchronization relationship with the source synchronization block in the first document.

In some embodiments, after the second operation event and before the generating, in a second document, a reference synchronization block that has a synchronization relationship with the source synchronization block, the generation unit is further configured to:
determine an access permission of a user who performs the second operation event to the second document; and
in response to the user who performs the second operation event having no edit permission to the second document, refuse the generation of the reference synchronization block; or
in response to the user who performs the second operation event having an edit permission to the second document, determine whether the user who performs the second operation event has a read permission to the source synchronization block; and
in response to the user who performs the second operation event having a read permission to the source synchronization block, perform the step of generating, in a second document, a reference synchronization block that has a synchronization relationship with the source synchronization block; or
in response to the user who performs the second operation event having an edit permission to the second document but having no read permission to the source synchronization block, display a link to the source synchronization block in the second document, and refrain from generating the reference synchronization block.

In some embodiments, after the displaying a link to the source synchronization block in the second document, the control unit is further configured to:
in response to an access operation on the link to the source synchronization block, determine whether a user who performs the access operation has a read permission to the source synchronization block; and
in response to the user who performs the access operation having an access permission to the source synchronization block, make a jump to a unique access page for the source synchronization block; or
in response to the user who performs the access operation having no read permission to the source synchronization block, make a jump to a permission request page, the permission request page being used to request a permission to the source synchronization block.

In some embodiments, after the generating, in a second document, a reference synchronization block that has a synchronization relationship with the source synchronization block, the control unit is further configured to:
determine whether a user who performs the second operation event has a collaborator management permission to the reference synchronization block; and
in response to the user who performs the second operation event having a collaborator management permission to the reference synchronization block, grant a collaborator of the second document a read permission to the reference synchronization block; or
in response to the user who performs the second operation event having no collaborator management permission to the reference synchronization block, configure the user who performs the second operation event in collaborators of the second document to be allowed to view the reference synchronization block, or configure the user who performs the second operation event in the collaborators of the second document to be allowed to view the reference synchronization block, and display first prompt information to give a prompt that another collaborator of the second document is not allowed to view the reference synchronization block.

In some embodiments, the control unit is further configured to: in response to the source synchronization block being deleted from the first document, display first preset content at a position where the reference synchronization block is located in the second document.

In some embodiments, the control unit is further configured to: in response to the synchronization relationship between the source synchronization block and the reference synchronization block being released in the first document, refrain from displaying the reference synchronization block in the second document, and then display second preset content at a position where the reference synchronization block is originally located.

In some embodiments, the control unit is further configured to: in response to a user who views a target synchronization block having a read permission to the target synchronization block, display the target synchronization block, or in response to the user who views the target synchronization block having no read permission to the target synchronization block, refrain from displaying the target synchronization block, and then display third preset content at a position where the target synchronization block is located, where the target synchronization block is the source synchronization block or the reference synchronization block.

In some embodiments, the control unit is further configured to: in response to a user having a read permission to the first document, grant the user a read permission to a target synchronization block.

In some embodiments, the control unit is further configured to: in response to a user having an edit permission to the first document, grant the user an edit permission to the target synchronization block.

In some embodiments, the control unit is further configured to: in response to a user having a unique authorization for the target synchronization block, determine a permission of the user to the target synchronization block based on the unique authorization.

In some embodiments, the control unit is further configured to: in response to a user having no read permission to the first document and having no unique authorization for the target synchronization block, determine that the user has no access permission to the target synchronization block,
where a user who has a read permission or an edit permission to the target synchronization block has an access permission to the target synchronization block, and the target synchronization block is the source synchronization block or the reference synchronization block.

In some embodiments, the control unit is further configured to: display a list of synchronization documents in response to a third operation event on a fourth control associated with a target synchronization block, where the target synchronization block is the source synchronization block or the reference synchronization block, and the list of synchronization documents includes: a document identifier of a document having the source synchronization block, and a document identifier of a document having the reference synchronization block.

In some embodiments, the control unit is further configured to: display the fourth control in response to a user who accesses the target synchronization block having a read permission to the synchronization block.

In some embodiments, an identifier of a document to which a user who performs the third operation event has a view permission is displayed in the list of synchronization documents.

In some embodiments, the control unit is further configured to: display second prompt information in the list of synchronization documents, to give a prompt of a number of document identifiers that are not displayed in the list of synchronization documents.

In some embodiments, the control unit is further configured to: in response to a synchronization relationship of the target synchronization block being released, refrain from displaying the fourth control associated with the synchronization block.

In some embodiments, the number of document identifiers in the list of synchronization documents is displayed in the fourth control.

In some embodiments, a document identifier of the first document, in which the source synchronization block is located, in the list of synchronization documents is associated with a first mark.

In some embodiments, a document identifier of a current document, in which the target synchronization block is located, in the list of synchronization documents is associated with a second mark.

In some embodiments, the control unit is further configured to: in response to a fourth operation event on the document identifier in the list of synchronization documents, open a document to which the document identifier subjected to the fourth operation event is pointing, and locate to a target synchronization block in the document.

In some embodiments, the control unit is further configured to: in response to a fifth operation event based on the source synchronization block, release synchronization relationships between the source synchronization block and all the reference synchronization blocks.

In some embodiments, the control unit is further configured to: in response to a user who performs the fifth operation event having no edit permission to the first document, refuse the release of the synchronization relationships between the source synchronization block and all the reference synchronization blocks.

In some embodiments, the control unit is further configured to: after the synchronization relationships between the source synchronization block and all the reference synchronization blocks are released, convert the content of the source synchronization block into content of a non-synchronization block in the first document.

In some embodiments, after the synchronization relationships between the source synchronization block and all the reference synchronization blocks are released, a link to the source synchronization block is made inaccessible.

In some embodiments, the control unit is further configured to: after the synchronization relationships between the source synchronization block and all the reference synchronization blocks are released, in response to the link to the source synchronization block being pasted into a third document, refrain from generating a reference synchronization block in the third document.

In some embodiments, the control unit is further configured to: in response to an operation of undoing the fifth operation event, restore the synchronization relationships between the source synchronization block and all the reference synchronization blocks.

In some embodiments, the control unit is further configured to: in response to a sixth operation event based on the reference synchronization block in the second document, release the synchronization relationship between the reference synchronization block in the second document and the source synchronization block.

In some embodiments, the control unit is further configured to: in response to a user who performs the sixth operation event having no edit permission to the second document or having no copy permission to the reference synchronization block, refuse the release of the synchronization relationship between the reference synchronization block in the second document and the source synchronization block.

In some embodiments, the control unit is further configured to: after the synchronization relationship between the reference synchronization block in the second document and the source synchronization block is released, convert the content of the reference synchronization block in the second document into content of a non-reference synchronization block.

In some embodiments, after the synchronization relationship between the reference synchronization block in the second document and the source synchronization block is released, display of a document identifier of the second document in the list of synchronization documents is disabled.

In some embodiments, the control unit is further configured to: in response to an operation of undoing the sixth operation event, restore the reference synchronization block in the second document and the synchronization relationship between the reference synchronization block and the source synchronization block.

The apparatus embodiment is substantially corresponding to the method embodiment, and therefore for a related part, reference may be made to the part of the descriptions of the method embodiment. The apparatus embodiment described above is merely illustrative. The modules illustrated as separate modules may be or may not be separate. Some or all of the modules may be selected according to actual needs to achieve the objectives of the solutions of the embodiments, which can be understood and implemented by a person of ordinary skill in the art without involving any inventive effort.

The method and apparatus of the present disclosure have been described above based on the embodiments and application cases. In addition, the present disclosure further provides an electronic device and a computer-readable storage medium. The electronic device and the computer-readable storage medium are described below.

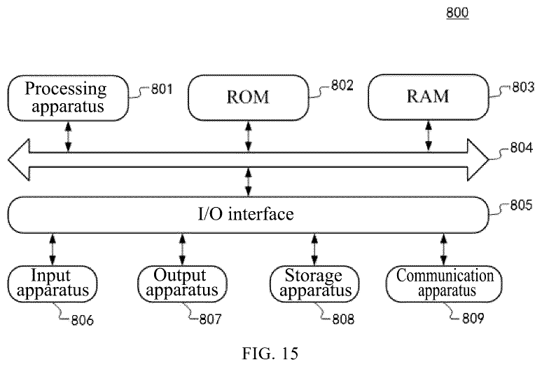

Referring to FIG. 15 below, there is shown a schematic diagram of a structure of an electronic device (such as a terminal device or a server) 800 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in the figure is merely an example, and shall not impose any limitation on the function and scope of use of the embodiments of the present disclosure.

The electronic device 800 may include a processing apparatus (e.g., a central processing unit, a graphics processing unit, etc.) 801 that may perform a variety of appropriate actions and processing in accordance with a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although the figure shows the electronic device 800 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 809 and installed, installed from the storage apparatus 808, or installed from the ROM 802. When the computer program is executed by the processing apparatus 801, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs, and the one or more programs, when executed by the electronic device, cause the electronic device to perform the above method according to the present disclosure.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a unit does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, an information processing method is provided. The method includes:
creating a source synchronization block in a first document in response to a first operation event; and
in response to a second operation event, generating, in a second document, a reference synchronization block that has a synchronization relationship with the source synchronization block,
where the synchronization relationship includes: content in the source synchronization block being kept the same as content in the reference synchronization block, and an update to the content in the source synchronization block being synchronized with the content in the reference synchronization block; and an update to the content in the reference synchronization block being synchronized with the content in the source synchronization block.

According to one or more embodiments of the present disclosure, the information processing method is provided, where the creating a source synchronization block in a first document in response to a first operation event includes:
creating an empty source synchronization block in the first document in response to a trigger operation on a first control for the first document; or
in response to a trigger operation on a second control associated with a first content block of the first document, converting the first content block into the source synchronization block, the source synchronization block in the first document having original first content in the first content block; or
in response to a preset operation on second content in the first document, displaying a third control associated with second content; and creating the source synchronization block in the first document in response to a trigger operation on the third control, the source synchronization block having the second content.

According to one or more embodiments of the present disclosure, the information processing method is provided, where the method further includes at least one of the following:
in response to a user who performs the first operation event having no edit permission to the first document, refusing the creation of the source synchronization block in the first document.

The method further includes: granting a user of the first document a permission to the source synchronization block, where the permission of the user of the first document to the source synchronization block is the same as a permission of the user of the first document to the first document.

The content in the source synchronization block and the content in the reference synchronization block include: one or more of text, an image, a video, a document, a form, and a content block of a non-synchronization block, the content block being a basic unit that carries document content.

The content in the source synchronization block and the content in the reference synchronization block do not include: another source synchronization block or another reference synchronization block.

According to one or more embodiments of the present disclosure, the information processing method is provided, where the method further includes at least one of the following:
in response to a user having a comment permission to a document in which a target synchronization block is located, granting the user a comment permission to the target synchronization block in the document, the target synchronization block being the source synchronization block or the reference synchronization block;
in response to the user having no comment permission to the document in which the target synchronization block is located, refraining from granting the user the comment permission to the target synchronization block in the document; and
in response to a comment operation on content in the target synchronization block, displaying comment information in a document in which commented content is located, and performing at least one of the following: refraining from synchronizing the comment information to another document, and sending a notification message to a user associated with the document in which the commented content is located.

According to one or more embodiments of the present disclosure, the information processing method is provided, where the second operation event includes:
an operation of copying the source synchronization block or a link to the source synchronization block into the second document; or
an operation of copying another reference synchronization block or a link to the other reference synchronization block into the second document, where the other reference synchronization block has a synchronization relationship with the source synchronization block in the first document.

According to one or more embodiments of the present disclosure, the information processing method is provided, where after the second operation event and before the generating, in a second document, a reference synchronization block that has a synchronization relationship with the source synchronization block, the method further includes:
determining an access permission of a user who performs the second operation event to the second document; and
in response to the user who performs the second operation event having no edit permission to the second document, refusing the generation of the reference synchronization block; or
in response to the user who performs the second operation event having an edit permission to the second document, determining whether the user who performs the second operation event has a read permission to the source synchronization block; and
in response to the user who performs the second operation event having a read permission to the source synchronization block, performing the step of generating, in a second document, a reference synchronization block that has a synchronization relationship with the source synchronization block; or
in response to the user who performs the second operation event having an edit permission to the second document but having no read permission to the source synchronization block, displaying a link to the source synchronization block in the second document, and refraining from generating the reference synchronization block.

According to one or more embodiments of the present disclosure, the information processing method is provided, where after the displaying a link to the source synchronization block in the second document, the method further includes:
in response to an access operation on the link to the source synchronization block, determining whether a user who performs the access operation has a read permission to the source synchronization block; and
in response to the user who performs the access operation having an access permission to the source synchronization block, making a jump to a unique access page for the source synchronization block; or
in response to the user who performs the access operation having no read permission to the source synchronization block, making a jump to a permission request page, the permission request page being used to request a permission to the source synchronization block.

According to one or more embodiments of the present disclosure, the information processing method is provided, where after the generating, in a second document, a reference synchronization block that has a synchronization relationship with the source synchronization block, the method further includes:
determining whether a user who performs the second operation event has a collaborator management permission to the reference synchronization block; and
in response to the user who performs the second operation event having a collaborator management permission to the reference synchronization block, granting a collaborator of the second document a read permission to the reference synchronization block; or
in response to the user who performs the second operation event having no collaborator management permission to the reference synchronization block, configuring the user who performs the second operation event in collaborators of the second document to be allowed to view the reference synchronization block, or configuring the user who performs the second operation event in the collaborators of the second document to be allowed to view the reference synchronization block, and displaying first prompt information to give a prompt that another collaborator of the second document is not allowed to view the reference synchronization block.

According to one or more embodiments of the present disclosure, the information processing method is provided, where the method further includes at least one of the following:
in response to the source synchronization block being deleted from the first document, displaying first preset content at a position where the reference synchronization block is located in the second document;
in response to the synchronization relationship between the source synchronization block and the reference synchronization block being released in the first document, refraining from displaying the reference synchronization block in the second document, and then displaying second preset content at a position where the reference synchronization block is originally located; and
in response to a user who views a target synchronization block having a read permission to the target synchronization block, displaying the target synchronization block, or in response to the user who views the target synchronization block having no read permission to the target synchronization block, refraining from displaying the target synchronization block, and then displaying third preset content at a position where the target synchronization block is located, where the target synchronization block is the source synchronization block or the reference synchronization block.

According to one or more embodiments of the present disclosure, the information processing method is provided, where the method further includes at least one of the following:
in response to a user having a read permission to the first document, granting the user a read permission to a target synchronization block;
in response to a user having an edit permission to the first document, granting the user an edit permission to the target synchronization block;
in response to a user having a unique authorization for the target synchronization block, determining a permission of the user to the target synchronization block based on the unique authorization; and
in response to a user having no read permission to the first document and having no unique authorization for the target synchronization block, determining that the user has no access permission to the target synchronization block,
where a user who has a read permission or an edit permission to the target synchronization block has an access permission to the target synchronization block, and the target synchronization block is the source synchronization block or the reference synchronization block.

According to one or more embodiments of the present disclosure, the information processing method is provided, where the method further includes:
displaying a list of synchronization documents in response to a third operation event on a fourth control associated with a target synchronization block, where the target synchronization block is the source synchronization block or the reference synchronization block, and the list of synchronization documents includes: a document identifier of a document having the source synchronization block, and a document identifier of a document having the reference synchronization block.

According to one or more embodiments of the present disclosure, the information processing method is provided, where the method further includes at least one of the following:
displaying the fourth control in response to a user who accesses the target synchronization block having a read permission to the synchronization block;
displaying, in the list of synchronization documents, an identifier of a document to which a user who performs the third operation event has a view permission;
displaying second prompt information in the list of synchronization documents, to give a prompt of a number of document identifiers that are not displayed in the list of synchronization documents;
in response to a synchronization relationship of the target synchronization block being released, refraining from displaying the fourth control associated with the synchronization block,
where the number of document identifiers in the list of synchronization documents is displayed in the fourth control;
a document identifier of the first document, in which the source synchronization block is located, in the list of synchronization documents is associated with a first mark; and
a document identifier of a current document, in which the target synchronization block is located, in the list of synchronization documents is associated with a second mark; and
in response to a fourth operation event on the document identifier in the list of synchronization documents, opening a document to which the document identifier subjected to the fourth operation event is pointing, and locating to a target synchronization block in the document.

According to one or more embodiments of the present disclosure, the information processing method is provided, where the method further includes:
in response to a fifth operation event based on the source synchronization block, releasing synchronization relationships between the source synchronization block and all the reference synchronization blocks.

According to one or more embodiments of the present disclosure, the information processing method is provided, where the method further includes at least one of the following:
in response to a user who performs the fifth operation event having no edit permission to the first document, refusing the release of the synchronization relationships between the source synchronization block and all the reference synchronization blocks;
after the synchronization relationships between the source synchronization block and all the reference synchronization blocks are released, converting the content of the source synchronization block into content of a non-synchronization block in the first document;
after the synchronization relationships between the source synchronization block and all the reference synchronization blocks are released, making a link to the source synchronization block inaccessible; and
after the synchronization relationships between the source synchronization block and all the reference synchronization blocks are released, in response to the link to the source synchronization block being pasted into a third document, refraining from generating a reference synchronization block in the third document.

The method further includes: in response to an operation of undoing the fifth operation event, restoring the synchronization relationships between the source synchronization block and all the reference synchronization blocks.

According to one or more embodiments of the present disclosure, the information processing method is provided, where the method further includes:
in response to a sixth operation event based on the reference synchronization block in the second document, releasing the synchronization relationship between the reference synchronization block in the second document and the source synchronization block.

According to one or more embodiments of the present disclosure, the information processing method is provided, where the method further includes at least one of the following:
in response to a user who performs the sixth operation event having no edit permission to the second document or having no copy permission to the reference synchronization block, refusing the release of the synchronization relationship between the reference synchronization block in the second document and the source synchronization block;
after the synchronization relationship between the reference synchronization block in the second document and the source synchronization block is released, converting the content of the reference synchronization block in the second document into content of a non-reference synchronization block; and
after the synchronization relationship between the reference synchronization block in the second document and the source synchronization block is released, disabling display of a document identifier of the second document in the list of synchronization documents; and
The method further includes: in response to an operation of undoing the sixth operation event, restoring the reference synchronization block in the second document and the synchronization relationship between the reference synchronization block and the source synchronization block.

According to one or more embodiments of the present disclosure, an information processing apparatus is provided. The apparatus includes:
a creation unit configured to create a source synchronization block in a first document in response to a first operation event; and
a generation unit configured to, in response to a second operation event, generate, in a second document, a reference synchronization block that has a synchronization relationship with the source synchronization block,
where the synchronization relationship includes: content in the source synchronization block being kept the same as content in the reference synchronization block, and an update to the content in the source synchronization block being synchronized with the content in the reference synchronization block; and an update to the content in the reference synchronization block being synchronized with the content in the source synchronization block.

According to one or more embodiments of the present disclosure, a computer-readable storage medium is provided, which is configured to store program code that, when executed by a processor, causes the processor to perform the method described above.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. An information processing method, comprising:
creating a source synchronization block in a first document in response to a first operation event; and
in response to a second operation event, generating, in a second document, a reference synchronization block that has a synchronization relationship with the source synchronization block,
wherein the synchronization relationship comprises: content in the source synchronization block being kept the same as content in the reference synchronization block, and an update to the content in the source synchronization block being synchronized with the content in the reference synchronization block; and an update to the content in the reference synchronization block being synchronized with the content in the source synchronization block.

2. The method according to claim 1, wherein the creating a source synchronization block in a first document in response to a first operation event comprises:
creating an empty source synchronization block in the first document in response to a trigger operation on a first control for the first document; or
in response to a trigger operation on a second control associated with a first content block of the first document, converting the first content block into the source synchronization block, the source synchronization block in the first document having original first content in the first content block; or
in response to a preset operation on second content in the first document, displaying a third control associated with second content; and creating the source synchronization block in the first document in response to a trigger operation on the third control, the source synchronization block having the second content.

3. The method according to claim 1, wherein the method further comprises at least one of the following:
in response to a user who performs the first operation event having no edit permission to the first document, refusing the creation of the source synchronization block in the first document;
the method further comprises: granting a user of the first document a permission to the source synchronization block, wherein the permission of the user of the first document to the source synchronization block is the same as a permission of the user of the first document to the first document;
the content in the source synchronization block and the content in the reference synchronization block comprise: one or more of text, an image, a video, a document, a form, and a content block of a non-synchronization block, the content block being a basic unit that carries document content; and
the content in the source synchronization block and the content in the reference synchronization block do not comprise: another source synchronization block or another reference synchronization block.

4. The method according to claim 1, wherein the method further comprises at least one of the following:
in response to a user having a comment permission to a document in which a target synchronization block is located, granting the user a comment permission to the target synchronization block in the document, the target synchronization block being the source synchronization block or the reference synchronization block;
in response to the user having no comment permission to the document in which the target synchronization block is located, refraining from granting the user the comment permission to the target synchronization block in the document; and
in response to a comment operation on content in the target synchronization block, displaying comment information in a document in which commented content is located, and performing at least one of the following: refraining from synchronizing the comment information to another document, and sending a notification message to a user associated with the document in which the commented content is located.

5. The method according to claim 1, wherein the second operation event comprises:
an operation of copying the source synchronization block or a link to the source synchronization block into the second document; or
an operation of copying another reference synchronization block or a link to the other reference synchronization block into the second document, wherein the other reference synchronization block has a synchronization relationship with the source synchronization block in the first document.

6. The method according to claim 1, wherein after the second operation event and before the generating, in a second document, a reference synchronization block that has a synchronization relationship with the source synchronization block, the method further comprises:
determining an access permission of a user who performs the second operation event to the second document; and
in response to the user who performs the second operation event having no edit permission to the second document, refusing the generation of the reference synchronization block; or
in response to the user who performs the second operation event having an edit permission to the second document, determining whether the user who performs the second operation event has a read permission to the source synchronization block; and
in response to the user who performs the second operation event having a read permission to the source synchronization block, performing the step of generating, in a second document, a reference synchronization block that has a synchronization relationship with the source synchronization block; or
in response to the user who performs the second operation event having an edit permission to the second document but having no read permission to the source synchronization block, displaying a link to the source synchronization block in the second document, and refraining from generating the reference synchronization block.

7. The method according to claim 6, wherein after the displaying a link to the source synchronization block in the second document, the method further comprises:
in response to an access operation on the link to the source synchronization block, determining whether a user who performs the access operation has a read permission to the source synchronization block; and
in response to the user who performs the access operation having an access permission to the source synchronization block, making a jump to a unique access page for the source synchronization block; or
in response to the user who performs the access operation having no read permission to the source synchronization block, making a jump to a permission request page, the permission request page being used to request a permission to the source synchronization block.

8. The method according to claim 1, wherein after the generating, in a second document, a reference synchronization block that has a synchronization relationship with the source synchronization block, the method further comprises:
determining whether a user who performs the second operation event has a collaborator management permission to the reference synchronization block; and
in response to the user who performs the second operation event having a collaborator management permission to the reference synchronization block, granting a collaborator of the second document a read permission to the reference synchronization block; or
in response to the user who performs the second operation event having no collaborator management permission to the reference synchronization block, configuring the user who performs the second operation event in collaborators of the second document to be allowed to view the reference synchronization block, or configuring the user who performs the second operation event in the collaborators of the second document to be allowed to view the reference synchronization block, and displaying first prompt information to give a prompt that another collaborator of the second document is not allowed to view the reference synchronization block.

9. The method according to claim 8, wherein the method further comprises at least one of the following:
in response to the source synchronization block being deleted from the first document, displaying first preset content at a position where the reference synchronization block is located in the second document;
in response to the synchronization relationship between the source synchronization block and the reference synchronization block being released in the first document, refraining from displaying the reference synchronization block in the second document, and then displaying second preset content at a position where the reference synchronization block is originally located; and
in response to a user who views a target synchronization block having a read permission to the target synchronization block, displaying the target synchronization block, or in response to the user who views the target synchronization block having no read permission to the target synchronization block, refraining from displaying the target synchronization block, and then displaying third preset content at a position where the target synchronization block is located, wherein the target synchronization block is the source synchronization block or the reference synchronization block.

10. The method according to claim 1, wherein the method further comprises at least one of the following:
in response to a user having a read permission to the first document, granting the user a read permission to a target synchronization block;
in response to a user having an edit permission to the first document, granting the user an edit permission to the target synchronization block;
in response to a user having a unique authorization for the target synchronization block, determining a permission of the user to the target synchronization block based on the unique authorization; and
in response to a user having no read permission to the first document and having no unique authorization for the target synchronization block, determining that the user has no access permission to the target synchronization block,
wherein a user who has a read permission or an edit permission to the target synchronization block has an access permission to the target synchronization block, and the target synchronization block is the source synchronization block or the reference synchronization block.

11. The method according to claim 1, wherein the method further comprises:
displaying a list of synchronization documents in response to a third operation event on a fourth control associated with a target synchronization block, wherein the target synchronization block is the source synchronization block or the reference synchronization block, and the list of synchronization documents comprises: a document identifier of a document having the source synchronization block, and a document identifier of a document having the reference synchronization block.

12. The method according to claim 11, wherein the method further comprises at least one of the following:
displaying the fourth control in response to a user who accesses the target synchronization block having a read permission to the synchronization block;
displaying, in the list of synchronization documents, an identifier of a document to which a user who performs the third operation event has a view permission;
displaying second prompt information in the list of synchronization documents, to give a prompt of a number of document identifiers that are not displayed in the list of synchronization documents;
in response to a synchronization relationship of the target synchronization block being released, refraining from displaying the fourth control associated with the synchronization block,
wherein the number of document identifiers in the list of synchronization documents is displayed in the fourth control;
a document identifier of the first document, in which the source synchronization block is located, in the list of synchronization documents is associated with a first mark; and
a document identifier of a current document, in which the target synchronization block is located, in the list of synchronization documents is associated with a second mark; and
in response to a fourth operation event on the document identifier in the list of synchronization documents, opening a document to which the document identifier subjected to the fourth operation event is pointing, and locating to a target synchronization block in the document.

13. The method according to claim 1, wherein the method further comprises:
in response to a fifth operation event based on the source synchronization block, releasing synchronization relationships between the source synchronization block and all the reference synchronization blocks.

14. The method according to claim 13, wherein the method further comprises at least one of the following:
in response to a user who performs the fifth operation event having no edit permission to the first document, refusing the release of the synchronization relationships between the source synchronization block and all the reference synchronization blocks;
after the synchronization relationships between the source synchronization block and all the reference synchronization blocks are released, converting the content of the source synchronization block into content of a non-synchronization block in the first document;
after the synchronization relationships between the source synchronization block and all the reference synchronization blocks are released, making a link to the source synchronization block inaccessible; and
after the synchronization relationships between the source synchronization block and all the reference synchronization blocks are released, in response to the link to the source synchronization block being pasted into a third document, refraining from generating a reference synchronization block in the third document; and
the method further comprises: in response to an operation of undoing the fifth operation event, restoring the synchronization relationships between the source synchronization block and all the reference synchronization blocks.

15. The method according to claim 1, wherein the method further comprises:
in response to a sixth operation event based on the reference synchronization block in the second document, releasing the synchronization relationship between the reference synchronization block in the second document and the source synchronization block.

16. The method according to claim 15, wherein the method further comprises at least one of the following:
in response to a user who performs the sixth operation event having no edit permission to the second document or having no copy permission to the reference synchronization block, refusing the release of the synchronization relationship between the reference synchronization block in the second document and the source synchronization block;
after the synchronization relationship between the reference synchronization block in the second document and the source synchronization block is released, converting the content of the reference synchronization block in the second document into content of a non-reference synchronization block; and
after the synchronization relationship between the reference synchronization block in the second document and the source synchronization block is released, disabling display of a document identifier of the second document in the list of synchronization documents; and
the method further comprises: in response to an operation of undoing the sixth operation event, restoring the reference synchronization block in the second document and the synchronization relationship between the reference synchronization block and the source synchronization block.

18. An electronic device, comprising:
at least one memory and at least one processor,
wherein the at least one memory is configured to store program code, and the at least one processor is configured to call the program code stored in the at least one memory to cause the at least one processor to:
create a source synchronization block in a first document in response to a first operation event; and
in response to a second operation event, generate, in a second document, a reference synchronization block that has a synchronization relationship with the source synchronization block,
wherein the synchronization relationship comprises: content in the source synchronization block being kept the same as content in the reference synchronization block, and an update to the content in the source synchronization block being synchronized with the content in the reference synchronization block; and an update to the content in the reference synchronization block being synchronized with the content in the source synchronization block.

19. The device according to claim 18, wherein the program code causing the at least one processor to create the source synchronization block in the first document in response to the first operation event further cause the at least one processor to:
create an empty source synchronization block in the first document in response to a trigger operation on a first control for the first document; or
in response to a trigger operation on a second control associated with a first content block of the first document, convert the first content block into the source synchronization block, the source synchronization block in the first document having original first content in the first content block; or
in response to a preset operation on second content in the first document, display a third control associated with second content; and creating the source synchronization block in the first document in response to a trigger operation on the third control, the source synchronization block having the second content.

20. A computer-readable storage medium configured to store program code that, when executed by a processor, causes the processor to:
create a source synchronization block in a first document in response to a first operation event; and
in response to a second operation event, generate, in a second document, a reference synchronization block that has a synchronization relationship with the source synchronization block,
wherein the synchronization relationship comprises: content in the source synchronization block being kept the same as content in the reference synchronization block, and an update to the content in the source synchronization block being synchronized with the content in the reference synchronization block; and an update to the content in the reference synchronization block being synchronized with the content in the source synchronization block.
